(19) United States
(12) Patent Application Publication
(10) Pub. No.: US 2007/0067216 A1
(43) Pub. Date: Mar. 22, 2007

(54) System and method of cooperative marketing of goods and services

(76) Inventors: Stephan C. Lowy, Neptune, NJ (US); Keith R. Lowy, Oakhurst, NJ (US)

Correspondence Address: Patrick D. McPherson;Duane Morris LLP, Suite 700, 1667 K Street, N.W., Washington, DC, 20006, US

(21) Appl. No.: 11/229,729

(22) Filed: Sep. 20, 2005

(51) Int. Cl. G06Q 30/00

(52) U.S. Cl. 705/14

(57) ABSTRACT

A system and method of delivering targeted marketing materials which allows the advertiser to associate itself and its products and services with a personal milestone of a prospective customer without using the normal delivery channels associated with junk mail or spam.

Traditional advertising has changed dramatically as advertisers have attempted to achieve more direct or targeted marketing to potential customers. Advertisers have long recognized that direct to target advertising results in a more successful marketing plan and thus have expended significant resources to assist the advertisers in identifying those potential customers more likely to purchase the advertisers' goods and services. In the past, mass distributions of blind advertisements through the postal distribution network or as an insert in local newspapers were designed to blanket large populations with the hope that the advisement would make their way to interested potential customers.

Technological developments have resulted in additional delivery mechanisms and have allowed conventional mass mailings to be supplanted by electronic delivery of the advertisements. Recently, however, there has been a backlash by customers against what is commonly referred to as junk mail, in the case of conventionally mailed advertisements, and referred to as spam in the case of unsolicited advertisements delivered by electronic mail. Due to the ever increasing amounts of spam being delivered to individual e-mail accounts, considerable ill will has developed against the providers of spam and legislative efforts have focused on restricting the distribution of spam.

In response to the problems identified above for mass marketing efforts, methods of more accurately targeting potential customers have been developed. U.S. Pat. No. 6,076,072 is one prior art example of a method of identifying potential customers for financial or insurance products and then delivering the advertising materials to the potential customer attached to routine non-advertising correspondence delivered to the customer, i.e., as an attachment to a credit card statement, utility bill, etc. Although the advertisement may be tailored to a specific type of individual and include personal information for the potential customer, i.e., birth date, the advertisements are still viewed as a type of targeted mass mailing that lack the personalized touches that is important to advertisers. Additionally, such advertising has privacy concerns as the advertiser must have access to personal information which raises issues of privacy concerns and legal protections. Direct marketing efforts, while potentially more successful than mass distribution methods, rely on the same delivery mechanism and thus are still considered by many potential customers as junk mail or spam and thus have not achieved widespread acceptance.

The present disclosure is directed to novel method of delivering targeted marketing materials which allows the advertiser to associate itself and its products and services with a personal milestone of a prospective customer without the need to access protected personal information for the potential customer.

### BRIEF DESCRIPTION OF THE DRAWINGS

FIG. 1 is a simplified pictorial representation of one embodiment of the present disclosure

### DETAILED DESCRIPTION OF THE DRAWINGS

In one aspect of the present disclosure, a sponsor identifies a milestone event in a prospective customer's lifetime, establishes an association with the milestone, and provides targeted promotional materials to the prospective customer. The sponsor may be an advertiser, a retailer, a professional organization or other entity that is desirous of establishing a relationship with the individual participating in the milestone event. The milestone event can be a moment of personal achievement such as graduation from a school, completion of a course of instruction, successfully passing an examination, receiving a promotion, getting married, participating in a religious ceremony, retirement, winning an athletic competition or any other event where recognition is provided through the awarding of a certificate to a recipient. For example, graduation from high school is a milestone event in most people's lives. Typically, at graduation, or shortly thereafter, a diploma is issued to the graduate memorializing the accomplishment of the graduation. The diploma typically contains the name of the graduate, the name of the issuing institution, a brief description of the curriculum or the degree awarded, the official seal of the institution with authorizing signatures. In one aspect of the present disclosure, a digital image of the diploma is made and merged with an image of the graduate, and a new image is created with the diploma merged with the recipient's image. This new personalized diploma can be presented by the issuing authority, i.e., school, or the sponsor to the recipient with promotional items from the sponsor. For example the promotional item may be a protective folder with the diploma that has imprinted on it the name of the sponsor. The sponsor may also provide an advertisement for specific products or services offered by the sponsor. The sponsor may also provide advertisements selected as a function of the curriculum completed. For example, graduates of a vocational school for automotive repair may receive a diploma personalized with the graduate's image, and also are provided with a rebate coupon for automotive products from a local automotive store. By way of another example, graduate of a beauty school may receive a diploma personalized with the graduate's image, and also receive an application to establish credit at a local beauty products supply store. Thus, the sponsor is providing the recipient of an award certificate for a milestone event with a personalized copy of the award certificate along with targeted marketing material using a delivery mechanism that avoids the pitfalls of junk mail or spam.

The awarding of any type of certificate to a recipient is an opportunity for a sponsor to associate itself with the awarding of the certificate in order to form an emotional/personal bond with the recipient. Targeting marketing in association with the creation of this emotional/personal bond has been shown to result in much more successful marketing efforts than in traditional direct advertising.

By way of an example only, a description of the present disclosure uses a diploma as the award certificate, but those of skill in the art will recognize that the award certificate maybe any one of many different types of certificates recognizing individual accomplishments including completion of a course of instruction, examination results, performance related achievement, athletic results, scholarship award, sweepstakes results, etc.

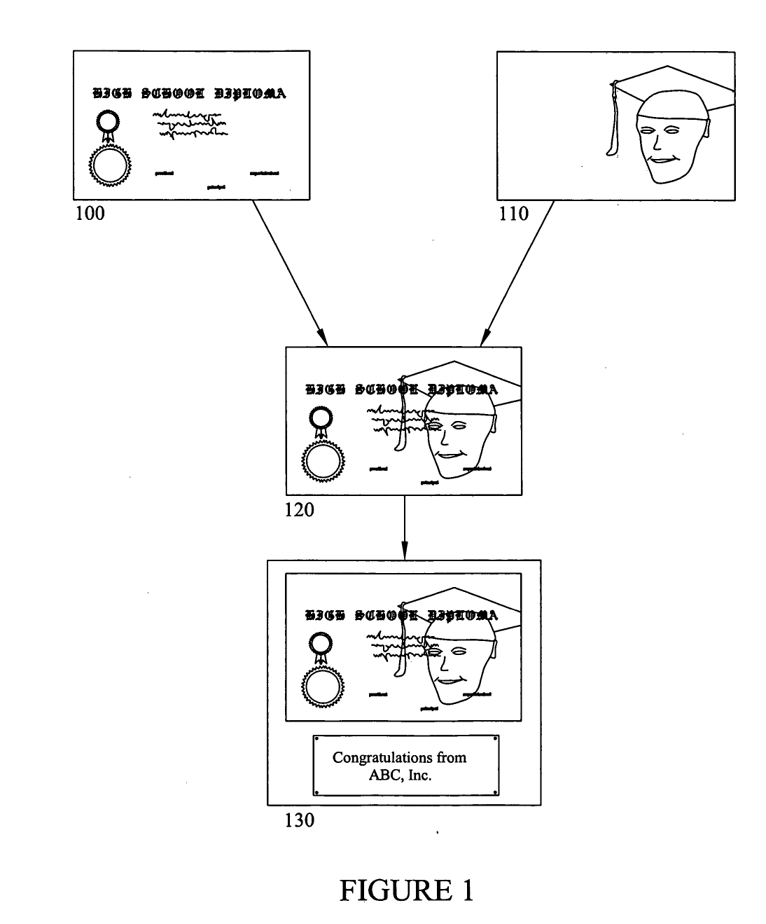

With reference to FIG. 1, an example of a personalized diploma is illustrated. A hard copy image of a diploma 100 is received from the issuing authority, and converted to a digital image. In the alternative, the issuing authority may provide a digitized image of the diploma. An image of the recipient 110 receiving the diploma is also received. The image of the recipient 110 may be a photograph, a digitized image or other likeness of the student. For example, the issuing authority may provide a digitized image of all diploma recipients, or the recipient images may be received from the entity that publishes yearbooks for the issuing authority. The image of the diploma 100 and the image of the recipient 110 are merged to form a third image 120 of the recipient's image 110 superimposed over the image of the diploma 100. Many different ways of combining the two images may be used. For example, a general purpose computer programmed with conventional imaging software and a conventional optical scanning device can be used to digitize the image of the diploma 100 and the image of the recipient 110 and combine the two images to form a third digitized composite image 120

The combined image 120 is then associated with a promotional item from the sponsor 130. For example, the sponsor may provide a protective cover 130 for the combined image 120 with a congratulatory message for the graduate identifying the sponsor. By way of another example, the sponsor may provide a protective folder for the combined image 120 containing promotional items for goods or services offered by the sponsor. The promotional items need not be for commercial services or products. For example, a professional organization may want to associate itself with the graduates of a course of instruction and offer membership in the organization to the graduates. Thus, a bar association may offer membership forms to the graduates of a law school with the combined image 120. By combining the personalized certificate with a promotional item, the sponsor has created an association between the sponsor and a special moment in the life of a prospective customer.

In one embodiment of the present disclosure, a number of different promotional items may be associated with the award certificate, and one or more promotional items is selected as a function of the type of award certificate. For example, the award certificate may be a diploma from a school offering several areas of concentration, and each concentration will have a different promotional item associated with it, i.e., recipients of law school diplomas receive discounted coupons for legal publications, and recipients of business school diplomas received discounts for accounting software. Thus, the promotional item may be selected as a function of the award certificate.

The combined image 120 may not supplant the official document issued by the issuing authority, but may be an additional more personalized momentum which provides a vehicle for targeting directed marketing to the recipient using a channel that has not previously been used in the prior art. It is contemplated that in order to encourage the issuing authority to agree to the issuing of the personalized combined image, the sponsor may agree to bear all costs of the issuance of the combined images without charge to the issuing authority or graduate.

The present disclosure provides a new conduit for direct marketing and advertising. It provides a new delivery system for sponsors to brand their name and image with each recipient of the personal image diploma by taking a very powerful and profound moment of achievement and acknowledging that moment with a personalized diploma creating a personal/emotional bond between the sponsor and the recipient.

The issuing authority can be high schools, colleges, graduate schools, trade and vocational schools, military institutions and train facilities. In addition, the schools or courses of instruction do not need to be associated with the achievement of humans. For example, a certificate of completion for a dog obedience school can be personalized with the image of the dog and presented to the dog owner with a promotional item from the sponsor, e.g., discount coupon for dog food.

In one embodiment, the recorded moment is an image of the recipient of the certificate. In another embodiment, the recorded moment may be an audio clip which may contain an audio portion related to the certificate received by the recipient. The audio clip may be in addition to the combined image 120 or in lieu of the combined image; i.e., the audio clip is provided on a media which is included with the protective cover for the official certificate such as a compact disc (CD), audio tape or other media compatible with conventional audio playback devices.

In another embodiment, a video clip, with or without an audio portion is provided of the recorded moment associated with the awarding of the certificate. For example, the video clip may be a montage of events during the recipient's course of training and be contained on a DVD, VHS tape or other media compatible with conventional video playback devices.

In a further embodiment, the image of the recipient may be in the form of a hologram, and thus the combined image will have a hologram superimposed on the certificate image.

While preferred embodiments of the present invention have been described, it is to be understood that the embodiments described are illustrative only and the scope of the invention is to be defined solely by the appended claims when afforded a full range of equivalents, many variations and modifications naturally occurring to those of skill in the art form a perusal hereof.

What is claimed:

1. A method of providing promotional materials comprising the steps of:
(a) receiving a first image of an award certificate for a recipient;
(b) receiving a second image of the recipient;
(c) merging the first and second images to provide a third image;
(d) selecting at least one promotional item for a product or service for the recipient; and
(e) providing the third image and the at least one selected promotional item to the recipient.

2. The method of claim 1 wherein the step of providing includes imprinting visually perceptible information on a protective cover and enclosing the third image in the protective cover.

3. The method of claim 2 wherein the visually perceptible information is an advertisement.

4. The method of claim 1 wherein the promotional item is a coupon for a discounted product or service.

5. The method of claim 1 wherein the promotional item is an advertisement.

6. The method of claim 1 wherein the first image is a diploma.

7. The method of claim 1 wherein first image is a certificate of completion for a course of instruction.

8. The method of claim 1 wherein the first image is a certificate of qualification for a specified skill.

9. The method claim 1 wherein the first image is a certificate of a test result.

10. The method of claim 1 wherein the first image is received electronically.

11. The method of claim 1 wherein the second image is a photograph of the recipient.

12. The method of claim 1 wherein the second image is a holographic image of the recipient

13. The method of claim 1 wherein the second image is received electronically.

14. The method of claim 1 wherein the at least one promotional item is selected as a function of the received first image.

15. The method of claim 1 wherein the step of providing includes electronic delivery of the third image and the at least one promotional item.
